(19) United States
(12) Patent Application Publication
(10) Pub. No.: US 2024/0024968 A1
(43) Pub. Date: Jan. 25, 2024

(54) THERMOSET BODY COUNTERSINK

(71) Applicant: AB SANDVIK COROMANT, Sandviken (SE)

(72) Inventors: Jason DODDS, Mapleton, UT (US); Aaron HOWCROFT, Mapleton, UT (US)

(21) Appl. No.: 18/220,961

(22) Filed: Jul. 12, 2023

Related U.S. Application Data
(60) Provisional application No. 63/391,076, filed on Jul. 21, 2022.

(51) Int. Cl. B23B 51/10; B23P 15/32

(52) U.S. Cl. CPC B23B 51/10; B23P 15/32

(57) ABSTRACT

A cutting tool having a thermoset molded body and a method of manufacturing the same is provided. The tool includes a tool body having opposed first and second ends. The tool body includes a cutting portion formed at the first end and a mounting portion formed between the cutting portion and the second end. A thermoset molded body is disposed on the tool body at the mounting portion. The thermoset body has a larger diameter than a diameter of the tool body. A cutting insert is positioned within and extends from the thermoset body.

### RELATED APPLICATION DATA

This application claims priority of U.S. Provisional Application No. 63/391,076, filed Jul. 21, 2022, which the entirety thereof is incorporated herein by reference.

### TECHNICAL FIELD

The present disclosure relates to a cutting tool having a thermoset countersink body with an insert and a method of adhering a thermoset body having an insert to the cutting tool.

### BACKGROUND

Known rotary cutting tools, such as countersinks, drills, reamers, etc. are commonly formed of a single tool body having a two-step diameter and made wholly from hardened materials or materials coated with a secondary, hardened material, for example, hardened steel, ceramic, cemented carbide, and/or cermet.

Referring to FIG. 1., a known cutting tool 10 including a countersink portion 12 typically is a two diameter stepped body having an operating end 14 and a tail end 16. The diameter of the tail end is often 2-2.5 times the diameter of the operating end.

The costs associated with producing such a single body tool is high due to the large amount of material needed for the tail end and the large amount of machining in order to produce a finished operating end.

Also, a cutting tool made from a single piece of material must be disposed of entirely or reconditioned when cutting edges become worn.

Thus, there is a need for improved cutting tools.

### SUMMARY

In one aspect there is provided a cutting tool comprising a tool body having opposed first and second ends, the tool body including a cutting portion formed at the first end and a mounting portion formed between the cutting portion and the second end; a thermoset molded body disposed on the tool body at the mounting portion, the thermoset body having a larger diameter than a diameter of the tool body; and a cutting insert at least partly extending from the thermoset body.

In another aspect there is provided a method of manufacturing a cutting tool comprising the steps of providing a tool body having opposed first and second ends, the tool body including a cutting portion formed at the first end and a mounting portion formed between the cutting portion and the second end; providing a mold having a plurality of mold sections; positioning a cutting insert on the mounting portion of the tool body or secured within one of the sections of the mold; positioning the mold sections about the mounting portion of the tool body; introducing thermoset material to the interior space of the mold to form a thermoset molded body around the cutting insert and the mounting portion of the tool body.

The present cutting tool uses a thermoset, composite countersink body to add diameter size changes to a straight, single diameter tool body. This simplifies the current manufacturing process by eliminating the need to use a multi-diameter blank, eliminating time consuming processes, and allowing for more standardization.

Using a thermoset, composite body increases cost efficiency. The present process reduces the cost per tool by removing costly steps, such as outer diameter grinding and brazing, and decreasing materials.

Using a thermoset, composite countersink body increases sustainability. The present disclosed process reduces the carbon footprint by eliminating the use of coolants used to turn down traditional blanks to the proper diameter, as coolant becomes contaminated during turning operations and needs to be disposed of in a controlled method. Injecting a thermoset into re-useable molds eliminates this waste.

The present disclosed cutting tool and process decrease the cost of multi-diameter tools and increases manufacturability. The known method of adding a large step to a drill (for countersinking) involves a single piece construction that requires expensive materials with long lead times. These materials can also be limited in assortment.

The present method relates to molding a thermoset countersink body directly onto the drill. This results in a cheaper, lighter tool and facilitates inclusion of various additional components, such as a RFID chip.

Another aspect of the present disclosure relates to the adherence of a cutting insert to the countersink body. The utilization of a thermoset as an adhesive allows for a unique ability to insert new technology into the adhesive body. This accommodates better and easier implementation of digitalization.

The adhesive has a lower mass than traditional tools, which decreases the rotational inertia, therefore creating a more balanced tool and reducing the energy required for cutting. Decreased mass would also result in logistical benefits, such as lower shipping costs.

The connection between the insert and the thermoset can be improved by using a modified design of the insert's rear side, e.g. with protrusions/recesses. Moreover, the cutting insert can have a specific shape for improved adherence.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a perspective view of a known cutting tool.

FIG. 2 is a perspective view of the cutting tool of the present disclosure.

FIG. 3 is a perspective view of the tool body of the cutting tool of FIG. 2.

FIG. 4 is a cross-section of the cutting tool taken along Line IV-IV of FIG. 2.

FIG. 5 is an enlarged perspective view of the cutting insert of the cutting tool of FIG. 2.

FIGS. 6a-6c are progressive perspective views of the mold positioned to form the countersink body of the present disclosure.

FIG. 7 illustrates a process of manufacturing the cutting tool of the present disclosure.

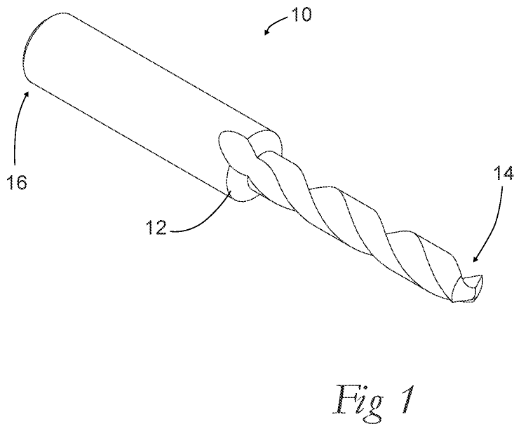

### DETAILED DESCRIPTION

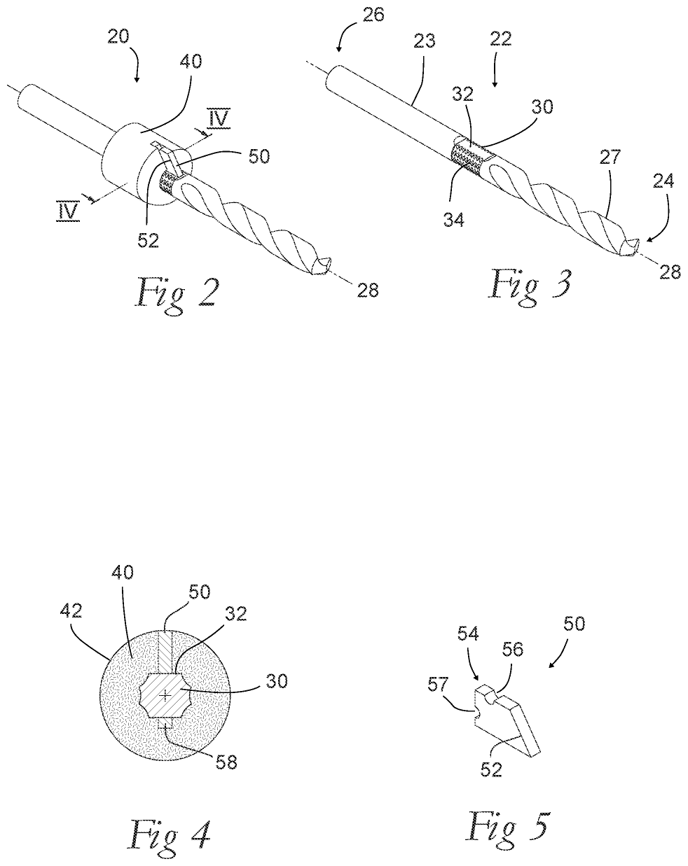

Referring to FIGS. 2 and 3, the present cutting tool 20 includes a tool body 22 formed of a single diameter blank. Tool body 22 is disposed to rotate about a central axis 28 and has a first, operating end 24 and an opposed second, tail end 26. A shank 23 is formed at tail end 26 of the tool body and is structured to be coupled to a machine tool (not shown). First end 24 forms a cutting portion 27 having a number of cutting edges structured to engage a workpiece (not shown). Tool body 22 can be made from hardened materials, for example, hardened steel, ceramic, cemented carbide, and/or cermet.

Although cutting portion 27 is shown as a drill, whereby for example cutting tool 20 is formed as a countersink drill, it should be appreciated that the tool could be of another type.

In addition to cutting portion 27 and shank 23, tool body 22 includes a mounting portion 30 disposed between cutting portion 27 and tail end 26.

As shown in FIG. 3, mounting portion 30 includes a seat 32 for receiving or supporting, at least partly, a cutting insert 50, as described further herein. As will also be described further herein, mounting portion 30 includes cross-hatching 34 on an outer surface thereof.

Referring again to FIG. 2, disposed around mounting portion 30 is a thermoset body 40 molded thereon having an outer surface 42 (FIG. 4). A thermoset material is herein defined as a material that becomes permanently rigid when heated/cured. For example, thermoset can refer to a thermosetting polymer or epoxy. There may be additives included with thermoset resin or epoxy to increase strength, wear, appearance, or other physical characteristics.

Thermoset body 40 forms an enlarged diameter section extending completely around the tool body, for example, forming a countersink.

Thermoset body 40 may be formed from a thermoset material, polymer or epoxy, for example, the composition can be any polymer and/or additives obtained by irreversible hardening or curing.

A length of thermoset body 40 should be preferably at least equal to the diameter of the tool body. The diameter of the body should be larger than the diameter of the tool it is being applied to.

Referring again to FIG. 2, insert 50 is positioned within the thermoset molded body, such that it is partly exposed and at least a part of a cutting edge 52 of the insert extends from the thermoset body 40. For example, at least ½ or more of the surface of the insert is embedded within the thermoset molded body and less than ½ of the surface of the insert extends from thermoset molded body 40. The part of the cutting insert thus exposed preferably includes at least the cutting edge 52 and a portion adjacent the cutting edge that forms a rake face of the cutting insert.

As will be described further herein, cutting insert 50 is attached to mounting portion 30 in a molding step.

The cross-hatch 34 on portion 30 improves adhesion of thermoset body 40. It should be appreciated that diamond or laser grinding wheels can be used to create the cross-hatching, however, other means can be used, as well as different shapes or textures can be provided. Moreover, different shapes of cutting insert 50 can be used to help adhesion to the tool and thermoset.

Various additional components 58, such as a RFID chip, can be provided within body 40. It should be appreciated that additional components could be thermocouple wires, strain gauge wires, rotation counters, or other sensors for measuring torque, thrust, vibration, sound, etc.

Referring to FIG. 5, cutting insert 50 has opposed ends. One end includes a cutting edge 52. An opposed second end 54 of insert 50 includes indentations 56, 57 or other details, which as described further herein assist in positioning of cutting insert 50 within the thermoset mold and/or increasing the adhesion to the thermoset. The second end 54 interacts with the mold to locate the insert within the mold. In the illustrated embodiment, a first indentation 56 located on an upper side of the insert, and thus facing an internal surface of one of the sections of the mold, may engage a protrusion in the surface of the mold that is arranged to temporarily fixate the cutting insert in the correct position with respect to the mounting portion 30 when the mold and the cutting insert are arranged to the tool body 22. A second indentation 57 located on a rear side of the cutting insert may help increase the adhesion between the cutting insert and the thermoset body.

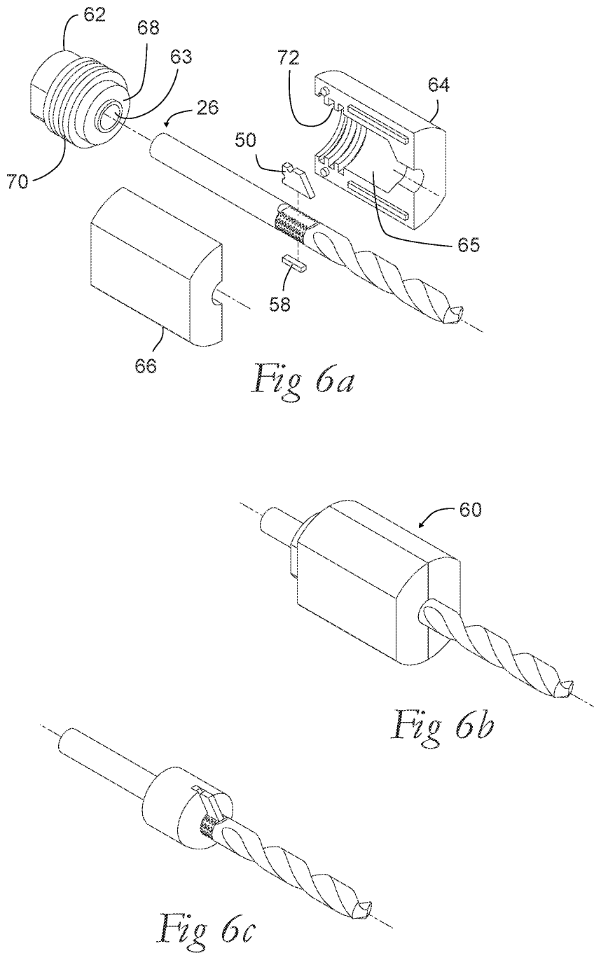

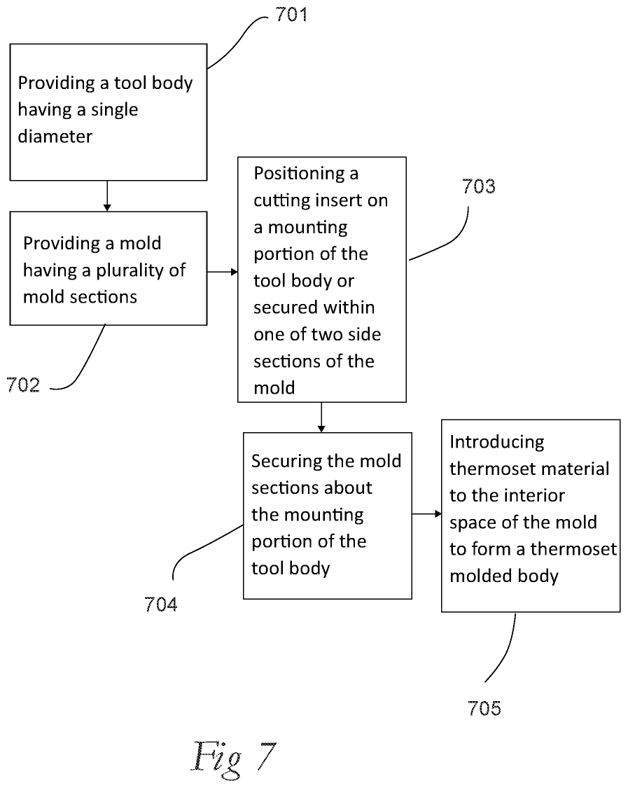

As discussed supra, thermoset body 40 is molded onto mounting portion of tool body 22. Referring to FIGS. 6a and 6b, three part mold 60 is utilized to form the thermoset body 40 in a manner that affixes body 40 to mounting portion of tool body 22. As described further herein, mold 60 is also configured to hold cutting insert 50 and component 58 in place. Insert 50 can be placed in the mold and the mold closed there around. A first portion of the insert is embedded within the thermoset molded body and a second portion of the insert extends beyond an outside surface of the thermoset molded body.

As shown in FIG. 6a, mold 60 includes three mating sections, a rear section 62 and two side sections 64, 66. Rear section 62 is formed as a cylinder having an inner cavity 63 for receiving end 26 of tool body 22 and is slidably movable thereon to position end 68 of rear section 62 at or close to mounting portion 30 of the tool body.

The end 68 of the rear section 62 creates a back wall of the mold. The rear section 62 includes threads 70 that mates with threads 72 (which appears on both section 64 and 66).

Each respective side section 64, 66 include internal surfaces 65 in the form of the outer shape of body 40 when coupled together. Moreover, side sections 64, 66 include coupling mechanisms to fix cutting insert 50 and component 58.

As shown in FIG. 6b, sections 62, 64 and 66 are assembled together about mounting portion 30 to encase the same, as well as, cutting insert 50 and component 58. As described further herein and as shown in FIG. 6c, body 40 is built about mounting portion 30 of tool body 22, insert 50 and component 58 after a thermoset molding process and mold sections 62, 64 and 66 have been removed.

The cutting tool 20 may include multiple thermoset bodies of different diameter, or a single thermoset body including multiple sections of different diameter, and with separate cutting inserts arranged at each such body or section of a body. Thereby, tools for machining even more complex geometries may be obtained.

As another aspect of the invention, a method of forming a cutting tool for use in rotary cutting operations is provided. Referring to FIG. 7, the method includes a first step 701 of providing elongated tool body 22, which has a single diameter along its axial length. As described above the tool body has opposed first and second ends. A cutting portion is formed at the first end and a mounting portion is formed between the cutting portion and the second end.

In a next step 702, mold 60 is provided. The mold is formed from one or more mold sections, which have a number of internal surfaces which define an interior space within the mold in the shape of the cutting tool when the mold is formed. Rear mold section 62 is slid over the tool body and positioned at or close to the mounting portion 30 of the shank such that end 68 of mold section 62 is located at, or close to, one end of the mounting portion.

In a next step 703, a cutting insert 50 can be positioned on the mounting portion of the tool body or secured with in one of two side sections 64, 66 of the mold. An RFID chip or other component can also be positioned within one of the mold side sections.

Thereafter, in a next step 704, the mold sections can be secured together about the mounting portion of the tool body, such that an interior space is formed within the mold that corresponds to the desired size and shape of the molded body.

As shown in FIG. 6b, insert 50, as well as any other components are located within the mold.

In a next step 705, according to known thermoset molding procedures, a quantity of thermoset material is introduced to the interior space of the mold and about the embedded portion of the cutting insert and any RFID chip to form a thermoset molded body within the mold. It should be appreciated that both the infusion method and compression method can be used for introducing the thermoset into the interior space. Thereafter, the thermoset material is allowed to set and the mold sections are removed.

Although the present embodiment(s) has been described in relation to particular aspects thereof, many other variations and modifications and other uses will become apparent to those skilled in the art. It is preferred therefore, that the present embodiment(s) be limited not by the specific disclosure herein, but only by the appended claims.

What is claimed is:

1. A cutting tool comprising:
a tool body having opposed first and second ends, the tool body including a cutting portion formed at the first end and a mounting portion formed between the cutting portion and the second end;
a thermoset molded body disposed on the tool body at the mounting portion, the thermoset body having a larger diameter than a diameter of the tool body; and
a cutting insert at least partly extending from the thermoset body.

2. The cutting tool of claim 1, wherein the tool body is made of a hardened steel, ceramic, cemented carbide, and/or cermet.

3. The cutting tool of claim 1, wherein the thermoset molded body is a thermoset material made of a polymer or epoxy.

4. The cutting tool of claim 1, wherein the tool body has a uniform diameter along its axial length.

5. The cutting tool of claim 1, wherein a length of the thermoset molded body is at least equal to a diameter of the tool body.

6. The cutting tool of claim 1, wherein the cutting insert has opposed ends, a first end of the cutting insert including a cutting edge and a second end of the cutting insert including an indentation or mounting detail.

7. The cutting tool of claim 1, wherein a first portion of the insert is embedded within the thermoset molded body and a second portion of the insert extends beyond an outside surface of the thermoset molded body.

8. The cutting tool of claim 7, wherein the second portion includes a cutting edge of the insert.

9. The cutting tool of claim 1, wherein the thermoset molded body includes a RFID chip therein.

10. The cutting tool of claim 1, wherein the cutting insert is positioned within the thermoset molded body such that at least ½ of the surface of the insert is embedded within the thermoset molded body.

11. The cutting tool of claim 1, wherein a cutting edge of the insert extends from the thermoset molded body.

12. A method of manufacturing a cutting tool comprising the steps of:
providing a tool body having opposed first and second ends, the tool body including a cutting portion formed at the first end and a mounting portion formed between the cutting portion and the second end;
providing a mold having a plurality of mold sections;
positioning a cutting insert on the mounting portion of the tool body or secured within one of the sections of the mold;
positioning the mold sections about the mounting portion of the tool body;
introducing thermoset material to the interior space of the mold to form a thermoset molded body around the cutting insert and the mounting portion of the tool body.

13. The method of claim 12, wherein the cutting insert is positioned within the thermoset molded body such that at least ½ of the surface of the insert is embedded within the thermoset molded body.

14. The method of claim 12, further comprising the step of positioning a RFID chip or other component within the mold.
